(19) United States
(12) Patent Application Publication
(10) Pub. No.: US 2004/0018074 A1
(43) Pub. Date: Jan. 29, 2004

(54) Assembly for removably supporting cargo on a vehicle

(76) Inventor: Scott Elder, Pompano Beach, FL (US)

Correspondence Address: MALLOY & MALLOY, P.A., Historic Coral Way, 2800 S.W. Third Avenue, Miami, FL, 33129, US

(21) Appl. No.: 10/632,205

(22) Filed: Jul. 29, 2003

Related U.S. Application Data
(63) Continuation-in-part of application No. 09/842,498, filed on Apr. 25, 2001, now Pat. No. 6,599,078.

(51) Int. Cl. B60P 9/00

(52) U.S. Cl. 414/462

(57) ABSTRACT

An assembly for positioning and removably supporting cargo on the exterior of a vehicle, wherein the cargo may be mobile or mounted on a mobile carrier assembly, such as a hand truck. A hoist assembly includes a winch having a supporting cable, a stanchion and a boom adjustably disposable relative to the stanchion all connected to a base which is removably secured to a hitch structure mounted on the vehicle. The support assembly includes a load support portion structured to support the load and/or cargo in a predetermined orientation, which in at least embodiment may be an inclined orientation. Controlled and secure positioning of the cargo relative to the load support portion is facilitated by selectively adjusting the boom relative to the stanchion.

### CLAIM OF PRIORITY

This patent application is a continuation-in-part of a currently pending patent application, namely, that having Ser. No. 09/842,498 and a filing date of Apr. 25, 2001, which is set to mature into U.S. Pat. No. 6,599,078 on Jul. 29, 2003. The afore-said “parent” patent application is hereby incorporated by reference in its entirety.

### BACKGROUND OF THE INVENTION

1. Field of the Invention

This invention relates to an assembly for positioning a mobile carrier or other load in a supported position on the exterior of a vehicle and comprises a hoist assembly and a support assembly. Both the load and the hoist assembly are concurrently mounted on the vehicle, preferably by being interconnected to the vehicle's hitch structure, wherein the mobile carrier may be positioned in and removed from its supported position without the cargo being repeatedly loaded on and unloaded from the carrier.

2. Description of the Related Art

It is common practice to carry various types of loads, cargo, etc. on the interior of vehicles. Depending on the weight of the load or cargo intended to be transported, it is also known to use some type of lifting device. Typically, such lifting devices are structured to lift and position the intended load into some part of the interior of the vehicle. As one example, pick-up trucks are specifically designed to use the truck bed as a support platform for the positioning of a variety of different loads on the truck. Also, with the increased popularity of sport utility vehicles (SUVs) the interior cargo area associated with such vehicles is also, in many cases, specifically designed for the containment of a variety of different types of cargo.

In addition to the above, more conventional motor vehicles, such as passenger automobiles and the like may in some instances be adapted for the mounting and support of a variety of different loads, cargo, etc. on the exterior thereof. In such instances, the use of auxiliary article carriers attached to some portion of the exterior of the vehicle has been attempted. However, the known or conventional mounting of carrier structures specifically designed to be secured to the exterior portion of a vehicle, for the transport thereof, typically requires that such article carriers be at least partially dismantled or otherwise modified in order to accomplish their secure mounting on the vehicle. The resulting problems and disadvantages associated with such known or conventional auxiliary article carriers are obvious and significant. More specifically, it is extremely inconvenient to the user of such known structures to assemble and/or disassemble various portions of the auxiliary carrier when it is desired to either load or unload the carrier onto the vehicle.

In addition to the above, such carrying devices are normally not capable of having an intended load or cargo maintained thereon during the loading and unloading procedure. As a result, each time an auxiliary carrier is secured to a vehicle or removed therefrom, the user must remove the intended cargo from the carrier, place it in a convenient location, and then re-load the cargo once the vehicle and supported carrier reaches an intended designation. The above procedure, in addition to being extremely inconvenient, also defeats the primary purpose of using article carriers since the user must repeatedly load and unload the cargo from the carrier, as set forth above.

By way of example only, a user who enjoys the sport of fishing frequently employs the use of a mobile carrier assembly such as, but not limited to, various types of hand propelled carts or the like. These devices are used to move various equipment, devices, and supplies which may be required during a day of fishing. Such mobile carrier assemblies are commonly used in the transport of the various equipment, supplies, etc. from a vehicle to a fixed land object where, such as a pier, jetty, etc. where the fishing is to be conducted. Obviously, to assist the transport of the aforementioned equipment and supplies to and from the vehicle to the fishing site the mobile carrier assembly is extremely helpful. However, often times such carrier assemblies, as generally set forth above, are difficult to load onto and remove from the transporting vehicle. Therefore, as with known or conventional auxiliary article carriers, it is not uncommon for the user to repeatedly load and unload all of the supplies during the mounting and removal of the carrier on and from the vehicle.

In addition to the time and inconvenience associated with such loading and unloading, it is also well recognized that such equipment, supplies, etc. can involve a considerable amount of weight, e.g., generally in the range of 200 pounds of more. Accordingly, it is readily apparent that the continuous and repeated handling of such equipment becomes a significant burden which seriously detracts from the intended enjoyment of fishing.

In an attempt to overcome the problems associated with the lifting, positioning and supporting of a variety of different loads, other than but including fishing supplies and equipment, the prior art has attempted to utilize a variety of lifting devices or winch assemblies. However, such known attempts typically involve situations where the winch is utilized to lift heavier than normal loads off the ground or other supporting surface and into or on an area or support platform specifically intended to store and support cargo. Therefore, known lifting devices are typically associated with pick-up trucks, vans, SUV's, etc. Such devices are not easily adaptable for use with conventional passenger cars. To the contrary, such passenger vehicles are best suited to have a carrier assembly, along with the cargo associated therewith secured to an exterior portion of the vehicle. Also, known lifting devices, of the type set forth above, frequently require their disassembly, once the cargo is loaded, in order that the vehicle may travel safely between intended locations.

Therefore, it is well recognized that there are long existing and significant problems relating to lifting, positioning and supporting of a variety of different cargos on a vehicle for the transport thereof between intended locations. Accordingly, a need exists for an assembly capable of facilitating the storage of a mobile carrier assembly on the exterior of virtually any type of motor vehicle in a manner which eliminates the requirement or need for removing the cargo from the mobile carrier assembly during the loading and unloading procedure. If any such assembly were developed, it would preferably include the utilization of an effectively structured hoist assembly, which also may be mounted to the exterior of the vehicle concurrently to the mounting and support of the aforementioned mobile carrier assembly and cargo associated therewith. It is contemplated that the utilization of any such improved assembly would eliminate most, if not all, of the problems and disadvantages associated with the transporting of various supplies and equipment between locations, by means of a motor vehicle, and also eliminate the unnecessary requirement of repeated loading and unloading of mobile carrier assemblies used to transport an intended cargo to a site or location for use. Finally, if any such improved assembly were developed, it should also be durable, safe in its construction and use, and be capable of being connected to the exterior of the vehicle without requiring any unusual or significant structural modifications of the vehicle, thereby enabling the use of such an improved assembly available for a variety of different applications.

### SUMMARY OF THE INVENTION

The present invention is directed to an assembly structured to position a load, which is preferably, but not necessarily in the form of a mobile carrier assembly such as a hand truck, in a supported position on the exterior of a vehicle. In such a supported position, the load can be transported to various locations and upon arrival at an intended designation, the load can be quickly and easily removed from its supported position on the vehicle. Once so removed, the mobile carrier assembly or hand truck can travel over the ground or other supporting surface so as to further transport the load or cargo mounted thereon to an intended site of use. The load or cargo should remain secured to the hand truck during all phases of it being mounted on and removed from the exterior of the vehicle. As such, the need to repeatedly load and unload the cargo from the hand truck, as is common in conventional mobile carrier assemblies, is eliminated.

As will be described in greater detail hereinafter, the versatility of the assembly of the present invention allows for the positioning of a variety of different loads and associated cargos in a supported position on the vehicle. As such, the load and/or cargo may weigh several hundred pounds, wherein the weight limit is determined not only by the structural features of the assembly of the present invention, but also by the load restrictions of the hitch structure secured to the vehicle.

More specifically, the assembly of the present invention comprises a base which is connected to the exterior of a motor vehicle, preferably by means of interconnecting the base to a hitch structure. Further, the base is preferably removably connected to the hitch structure of the vehicle but, due to its relatively compact structure, may be left in place even when a load is not intended to be mounted on and transported by the vehicle.

In addition, at least one preferred embodiment of the assembly of the present invention includes a hoist assembly comprising a winch and a lifting cable connected thereto. The hoist assembly further includes a stanchion and a boom connected in outwardly extending relation to the stanchion, wherein the boom defines at least a portion of the path of travel of the cable between the winch and the load, to which the cable is attached.

Another feature of the assembly of the present invention includes the provision of a support assembly connected to the base and including individual support portions for concurrently supporting the hoist assembly and the load or mobile carrier assembly on the vehicle. More specifically, the support assembly includes at least a first or load support portion specifically structured to removably retain a portion of the hand truck or other mobile carrier assembly in a position or orientation which does not require the removal of cargo therefrom. Also, the support assembly includes at least a second support portion for the independent support of the hoist assembly, and in particular, the stanchion associated therewith. The second support portion is further structured to maintain the stanchion, the boom, the winch and the connecting cable all in a substantially operative position, concurrently to the support of the hand truck, on the exterior of the vehicle. The positioning of both the hoist assembly and the concurrently supported hand truck is such as to facilitate travel of the vehicle and secure attachment of the assembly on an exterior thereof in a safe manner.

Also, the versatility of the present invention is demonstrated by the ability to mount and support a variety of different loads, other than a hand truck or other mobile carrier, on the vehicle. Accordingly, the structure of the load may vary and be of different weights, sizes and configurations. However, when the load is in the form of a hand truck or like carrier, it may be mounted on and removed from the vehicle without necessitating the repetitive loading and unloading of the cargo therefrom.

Therefore, one feature of the present invention includes the structuring of the boom to have a selectively variable length, so as to extend outwardly from the stanchion into different positions. The boom, as set forth above, defines at least a portion of the path of travel of the connecting cable and as such, serves to position the connecting cable relative to the load. More specifically, the point of attachment of the connecting cable to the load may be varied dependent, at least in part, on the location of the center of gravity of the hand truck and/or cargo. Proper alignment of the cable and the center of gravity is important in maintaining a proper orientation of the hand truck and the cargo, so as to facilitate its positioning into and out of a preferred supported position on the vehicle by virtue of an interconnection of the base to the hitch structure associated with the vehicle.

In addition, the length of the boom may be selectively varied into different preferred positions depending on whether the hand truck and cargo are being mounted on or removed from the support assembly. Also, further adjustment of the boom, resulting in selective positioning of the connecting cable relative to the load, can be easily accomplished to accommodate a variety of different cargos mounted on the hand truck. Therefore, proper orientation of the load and cargo can be easily accomplished when the center of gravity of a particular cargo significantly differs from the last cargo mounted on and transported by the hand truck or like mobile carrier assembly.

Yet another preferred embodiment of the present invention is directed to another assembly that is also structured to position a load in a supported position on the exterior of a vehicle in supported and connected relation to a hitch assembly. However, distinguishing features of this preferred embodiment further demonstrate the versatility of the present invention by removably supporting the load, which in this embodiment is defined by the cargo and is absent the use of a hand truck or mobile carrier. While the various embodiments of the assembly of the present invention are adapted to support a plurality of different types of cargo on the vehicle, the particular cargo referred to in this embodiment is of the type which is mobile. The terms “mobile cargo” may be more specifically described as including its own wheel assembly or wheeled support incorporated therein. As such, the mobile cargo does not require the use of a hand truck or like mobile carrier to transport it over the ground or other supporting surface from one location to another. Therefore, use of a mobile carrier would be superfluous, even when the mobile cargo is mounted and supported on a vehicle for transportation. The terms or category of “mobile cargo” may include but, is most certainly not limited to, lawn mowers, snow blowers, power washers, generators, compressors, etc.

In supporting a mobile cargo in the intended manner, this alternative embodiment of the assembly of the present invention is substantially equivalent to that described above. Therefore, this alternative assembly also includes a base removably attachable to a hitch of a vehicle, wherein the base is disposed in supporting relation to the hoist assembly, including a stanchion and a boom connected in outwardly extending relation to the stanchion. As with previously described embodiments, the boom and the stanchion at least partially define a portion of the path of travel of a supporting cable extending from the winch to the load, where the free end of the cable is attached directly to the mobile cargo. In accomplishing such attachment, the boom may be selectively adjusted both towards and away from the stanchion in order to maintain control of and properly position the cargo relative to the load support portion immediately prior to the cargo being loaded, while it is supported, and as it is being removed.

As also set forth above, this preferred embodiment of the present invention includes a support assembly including the load support portion, which may also be considered and referred to herein as a cargo engaging or cargo retaining portion. The support assembly is also disposed and structured to support the hoist assembly, as set forth in the previously described embodiments. Accordingly, the load support portion is structured to removably engage and/or retain a portion of the cargo itself, rather than retaining or supporting a mobile carrier, as with previously described embodiments. As such, the supporting cable is attached directly to the mobile cargo which, as set forth in greater detail hereinafter, has a substantially consistent center of gravity. Therefore, the connection of the free end of the supporting cable to the mobile cargo occurs preferably at a fixed connecting point, due to the fixed center of gravity, which may or may not be specifically structured to receive a coupling structure attached to the free end of the cable. The connecting point at which the cable is connected to the cargo is preferably disposed in substantial alignment with the center of gravity of the cargo. However, the supporting cable may or may not be substantially aligned with the center of gravity of the mobile cargo, depending at least in part, on whether the cargo is being loaded onto the load support portion, supported thereby, or being removed therefrom.

More specifically, the connecting point or location where the free end of the support cable engages the mobile cargo should preferably be substantially aligned with the center of gravity of the cargo in order to maintain a preferred and controlled “upright” orientation of the cargo, especially, but not exclusively, when it is supported solely from the cable. However, as set forth above with regard to the previous embodiments, the boom is selectively adjustable along its length in outwardly spaced relation to the stanchion. Therefore, the selective longitudinal positioning of the boom relative to the stanchion serves to position the cargo in a desired location or proximity relative to the load support portion. The preferred relative proximity there-between will depend on whether the cargo is being loaded onto the support portion, supported thereon, or unloaded therefrom.

Other factors which may affect the selective adjustment or positioning of the boom relative to the stanchion include the positioning or parking of the vehicle on an inclined surface. For example, if the vehicle is parked on a downhill incline, the boom may be positioned to extend outwardly from the stanchion a somewhat greater than normal distance to facilitate an outward travel or “swinging” of the cargo away from the load support portion, such as when the cargo is being unloaded. Conversely, if the vehicle is parked in an uphill location, the boom may be disposed outwardly from the stanchion a relatively shorter distance, thereby somewhat limiting the outward travel of the cargo from the load support portion when being unloaded and bringing the cargo into closer proximity to the load support portion when it is being loaded onto the load support portion. Accordingly, the ability to selectively adjust the length of the boom in outwardly spaced relation to the stanchion enables an individual to maintain the desired proximity between the load support portion and the portion of the cargo which engages the load support portion.

Other structural features and components are associated with the assembly, particularly include the stanchion having one or more attachment members engaging the handle or other parts of the mobile cargo to further facilitate secure support of the mobile cargo on the assembly.

Yet another preferred embodiment of the present invention includes the assembly being structured to further demonstrate significant versatility by enabling its lifting and support of cargo onto the base, wherein the cargo has a height, configuration or other physical characteristic which renders the use of the stanchion and boom assembly as described above, less than totally efficient. More specifically, in this additional preferred embodiment, the assembly includes a base securely connected to a support assembly and a hoist assembly. As with the previously described embodiments, the hoist assembly includes a winch connected in driving relation to a supporting cable and a boom. The boom at least partially defines the path of the cable as it extends from the winch to its point of connection with the load being mounted on the vehicle.

In this additional preferred embodiment, the load is preferably defined by a hand truck or other mobile carrier connected to and supporting the cargo, wherein the cargo is most probably not of the type which is effectively mobile, as with the “mobile cargo” described above. Further, this embodiment of the assembly includes the support assembly comprising a load support portion disposed at a predetermined orientation preferably defined by an angular or inclined orientation, relative to the ground. The load support portion is connected to the base in interconnecting relation to the hitch structure of the vehicle. Further, the load support portion comprises a guide assembly. In order to properly dispose and position the supported load, including a mobile carrier and cargo in the preferred, predetermined orientation, the load support portion and the guide assembly are arranged at an incline or angular orientation. Such a preferred orientation facilitates secure supporting engagement of the load on the support assembly during travel of the vehicle, especially when the cargo comprises a significant height.

Other structural features of this preferred embodiment of the present invention include one or more attachment members connected to or mounted on the load support portion. These attachment members may or may not be substantially equivalent, in both structure and function, to the one or more attachment members secured to the stanchion in one or more of the previously described embodiments of the present invention.

It is, therefore, emphasized that the structural components of the various preferred embodiments of the assembly of the present invention are such that a variety of different load/cargo combinations may be positioned, mounted and supported on the base of the assembly. Moreover, the load/cargo combinations may or may not include the use of a supporting hand truck or like mobile carrier assembly dependent, at least in part, on the size and configuration of the cargo and whether or not the cargo is mobile, at least to the extent of having its own wheeled base or like structure.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a side view in partial phantom of a preferred embodiment of the positioning and mounting assembly of the present invention connected to a hitch structure associated with a motor vehicle.

FIG. 2 is a side view in partial phantom of a base and support assembly associated with the preferred embodiment of FIG. 1.

FIG. 3 is a top view of the embodiment of FIG. 2.

FIG. 4 is a front view of the embodiment of FIGS. 2 and 3.

FIG. 5 is a detailed view in partially exploded form and cutaway of a portion of a hoist assembly associated with the embodiment of FIG. 1.

FIG. 6 is a detailed view in partial cutaway showing interaction between a load and a portion of the hoist assembly of the embodiments of FIGS. 1 and 5.

FIG. 7 is a side view in partial cutaway of a preferred embodiment of a boom structure associated with the hoist assembly of the present invention.

FIG. 8 is a schematic representation of the sequential positioning of a portion of the load, during a mounting procedure, relative to the support assembly in accordance with the position of the boom as shown in FIG. 7.

FIG. 9 is a side view in partial cutaway of the embodiment of the boom of FIG. 7 in a different orientation.

FIG. 10 is a schematic representation showing the sequential positions of a portion of the load as it is being removed from the support assembly associated with the preferred embodiment of the present invention.

FIG. 11 is a side view in partial cutaway and phantom of another preferred embodiment of the present invention, wherein the load is defined by mobile cargo.

FIG. 12 is yet another preferred embodiment of the present invention wherein the load comprises a mobile carrier having cargo mounted thereon which is of a dimension and/or configuration to necessitate support of the load on a vehicle at a predetermined orientation.

FIG. 13 is a side view in partial schematic representing a load disposed on a supporting surface prior to being mounted on the vehicle.

FIG. 14 is a side view in partial schematic of a progressive step of the embodiment of FIG. 13, wherein in the load, including a mobile carrier, is connected to a hoist assembly to assume a predetermined position prior to it being lifted from a supporting surface.

FIG. 15 is a side view in partial schematic of the embodiment of FIGS. 13 and 14, wherein the load including a mobile carrier is disposed in the aforementioned predetermined orientation when lifted from the support surface and mounted on the vehicle.

Like reference numerals refer to like parts throughout the several views of the drawings.

### DETAILED DESCRIPTION OF THE PREFERRED EMBODIMENT

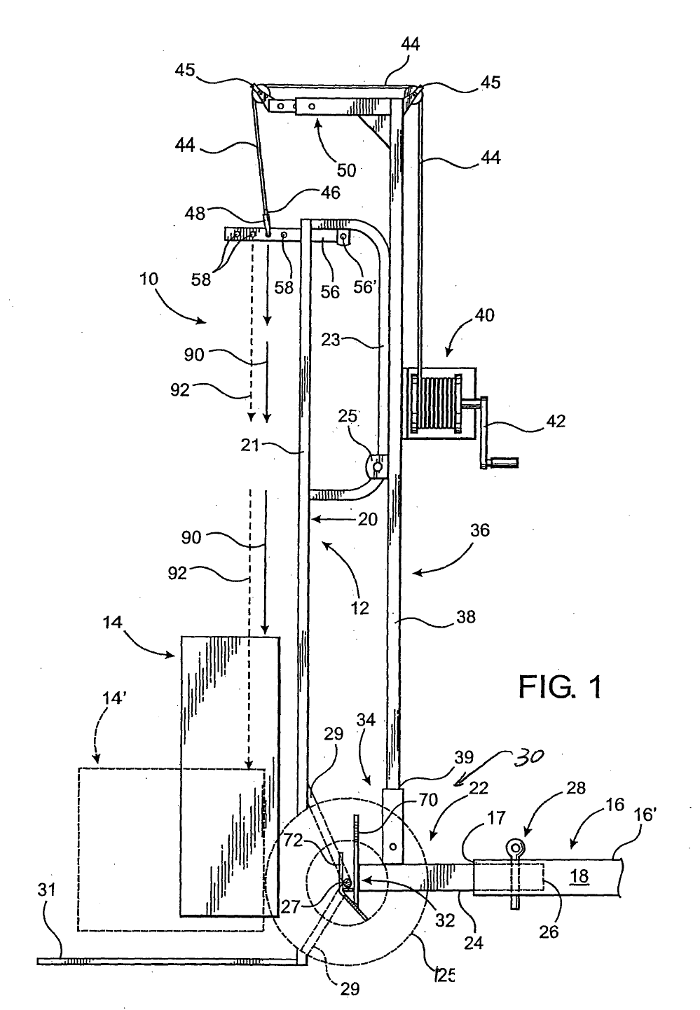

As shown in the accompanying drawings, the present invention is directed to an assembly generally indicated as 10, structured to position, mount and support a load, generally indicated as 12, with or without a plurality of different cargos generally indicated as 14 and/or 14′, mounted on the exterior of a vehicle. The assembly 10, is preferably secured to the vehicle by means of a hitch structure generally indicated as 16, which may be of conventional design. The hitch structure 16 is secured to the frame or undercarriage portion of the vehicle (not shown for purposes of clarity) and extends outwardly, preferably from the rear end thereof, into an accessible location, as shown in FIG. 1. The hitch structure 16 may be in the form of a “box-type” hitch having an elongated draw bar 16′ which includes a square or rectangular opening 17 communicating with a hollow interior 18 of similar configuration.

One preferred embodiment of the assembly 10 will be described in detail hereinafter with specific reference to the load 12 being in the form of a hand truck or like mobile carrier assembly, generally indicated as 20. However, it is emphasized that the load 12 may be defined by a variety of structures, other than the hand truck or mobile carrier assembly 20. In addition, the hand truck 20 or other structure defining the load 12, may be capable of removably supporting a variety of different equipment, supplies, objects, devices, appliances, etc. For purposes of clarity, all of the aforementioned items are generically categorized and referred to herein as “cargo” when describing the one or more preferred embodiments of the present invention.

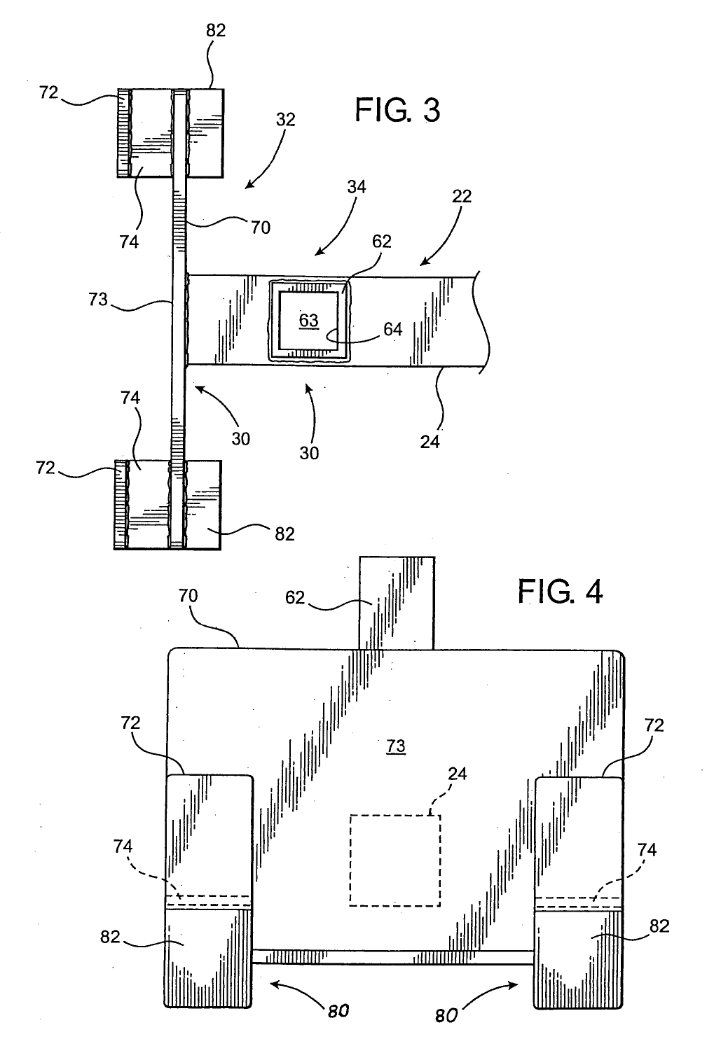

With reference to FIGS. 1 through 4, the preferred embodiment of the assembly 10 comprises a base generally indicated as 22 and including an elongated tongue 24. The tongue 24 is dimensioned and configured to be telescopically attached to the hitch structure 16, such as by having an outer end 26 thereof pass through the open end 17 and into the interior 18 of the draw bar 16′. In such a position, a locking device, such as a locking pin or other structure, generally indicated as 28, passes through aligned apertures cooperatively formed in both the draw bar 16′ and in the tongue 24.

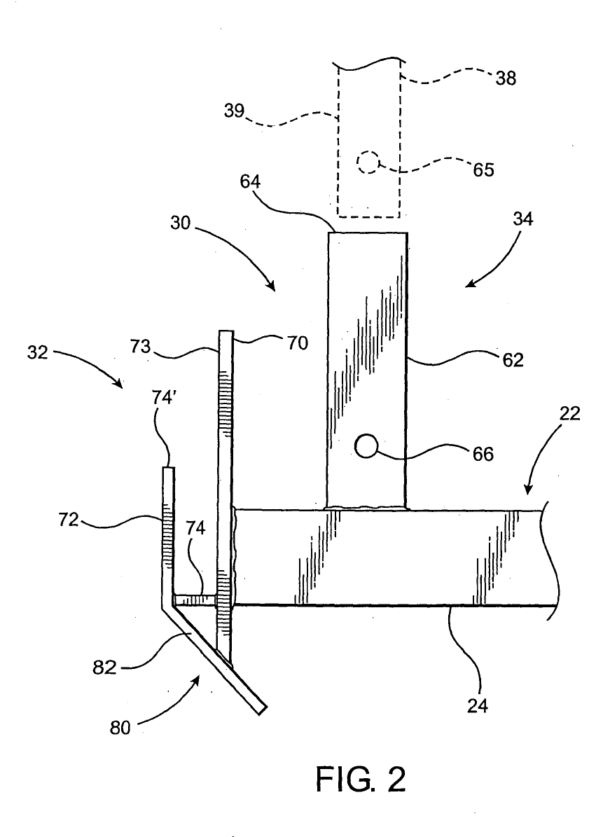

As best shown in FIGS. 2 through 4, the base 22 also includes a support assembly generally indicated as 30 being connected thereto. The support assembly 30 includes at least a first support portion generally indicated as 32 and a second support portion generally indicated as 34. The first and second support portions 32 and 34 respectively, are disposed, dimensioned and configured to concurrently support both the load 12 and a hoist assembly, generally indicated as 36, on the exterior of the vehicle by virtue of the secured but removable attachment of the base 22 to the hitch structure 16.

In the preferred embodiment of FIGS. 1 and 2, the hoist assembly 36 includes an elongated stanchion 38 having a lower end 39 secured to the second or stanchion support portion 34. The stanchion 38 is thereby maintained in an operative position, being vertically oriented so as to extend upwardly and outwardly from the base 22. As shown in FIG. 1, the hoist assembly 36 also includes a winch generally indicated as 40 which may be manually or otherwise powered by virtue of a crank arm and handle 42. An elongated connecting cable 44 is wound about and thereby connected in driven relation to the winch 40. The cable 44 may be movably connected to travel along at least a portion of the stanchion 38 by virtue of a plurality of pulleys 45. The free end 46 of the cable 44 includes an appropriate connector or hook 48 to facilitate attachment to the load 12, preferably defined by the hand truck or like mobile carrier assembly 20.

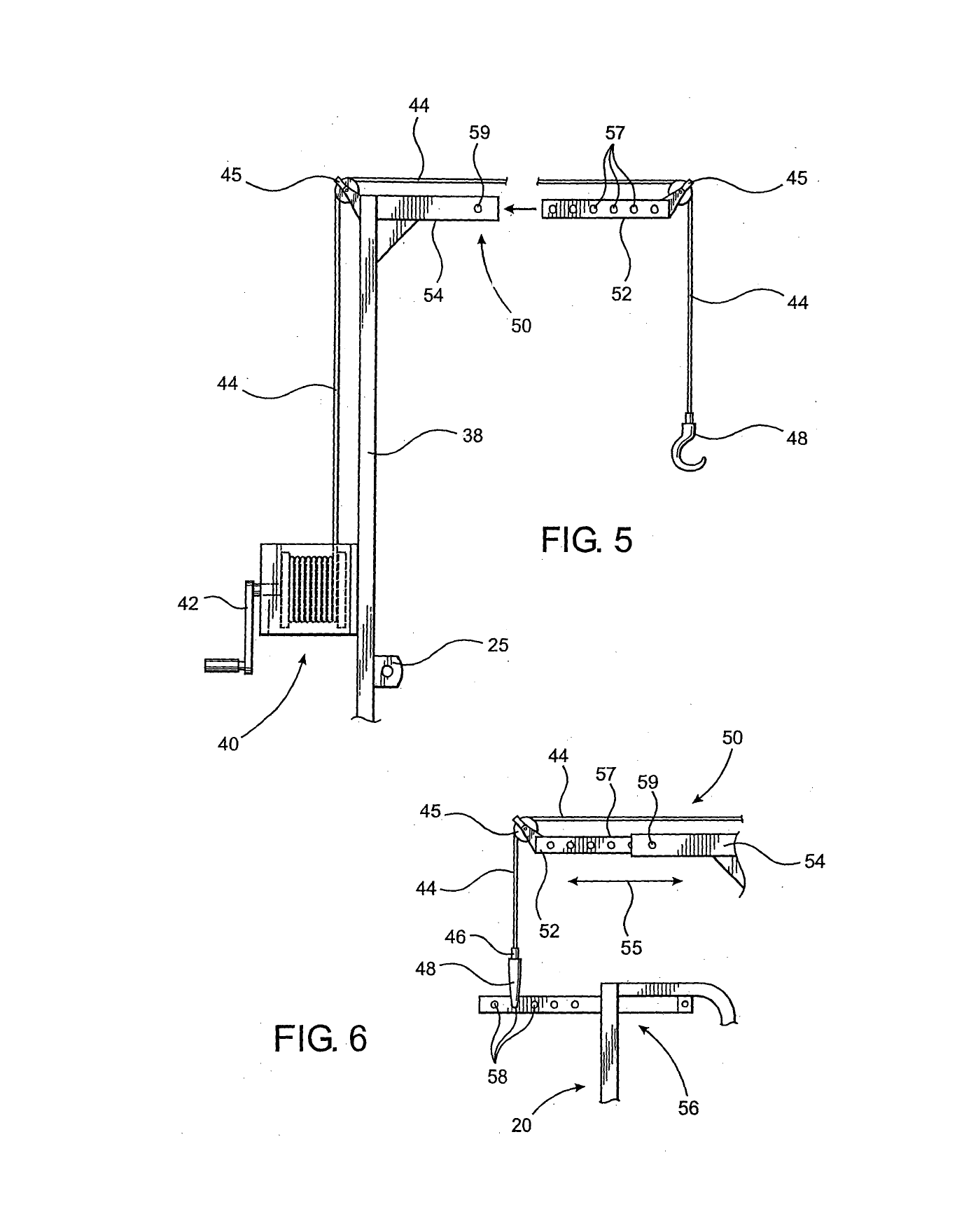

Still referring to FIG. 1, another feature of the assembly 10 is the provision of a boom, generally indicated as 50, connected to and extending laterally outward from the stanchion 38. As shown in FIGS. 5 and 6, the boom 50 includes at least one arm segment 52 slidingly attached, such as by a telescoping interconnection, to a sleeve-like structure, such as sleeve arm 54. The telescoping interconnection between the arm segment 52 and the sleeve arm 54 defines the boom 50 as having a variable length which may be selectively adjustable so as to properly orient or position the connecting cable 44 relative to the hand truck 20 or other load 12. Moreover, the segment arm 52 may be selectively positioned into and out of the sleeve arm 54, as indicated by directional arrow 55 in FIG. 5, thereby facilitating the establishment of the preferred length of the boom 50. As such, the segment arm 52, may be removably locked or fixed into any of a variety of different longitudinal positions relative to the sleeve arm 54 by virtue of a plurality of locking apertures 57. The locking apertures 57 are formed in the segment arm 52 and disposed in aligned relation with the opening or aperture 59 formed in the sleeve arm 54. A locking pin or other device may be used to accomplish the removable fixed or locked positioning of these two components.

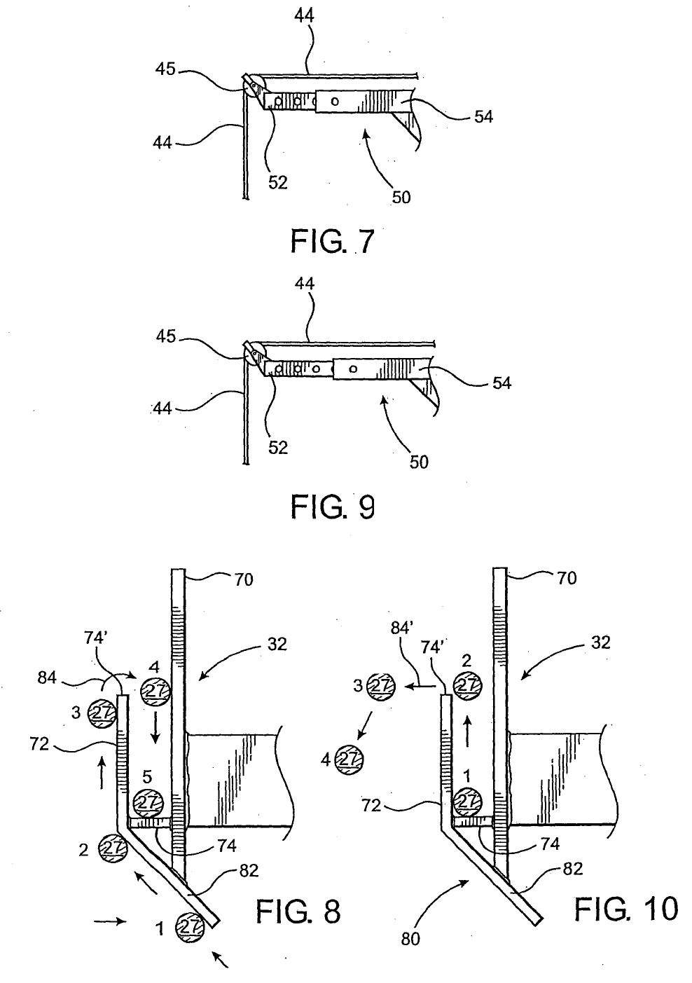

In order to further facilitate the proper positioning of the cable 44 and the connector 48 relative to the hand truck or like mobile carrier 20, a mounting arm 56 is secured to the hand truck 20 by a hinge-type connection 56′, as shown in FIG. 6. The mounting arm 56 includes a plurality of connecting apertures 58 to which the free end connector 48 of the connecting cable 44 may be attached. As will be explained hereinafter with specific reference to FIGS. 7 through 10, the proper positioning of the connecting cable 44 and the location of connection of the free end connector 48 to the hand truck 20 greatly facilitates both the mounting and removal of the hand truck 20 relative to the support assembly 22. Such proper positioning is at least partially dependent on the location of the center of gravity of the combined cargo 14, 14′ and the hand truck 20 and the alignment of the cable 44 with the combined center of gravity.

Again with primary reference to FIGS. 1 through 4, the support assembly 30, as set forth above, includes a second support portion 34 which may be more specifically described as a stanchion support portion. The stanchion support portion 34 includes an elongated sleeve 62 having a hollow interior 63 and an open end 64 through which the lower most end 39 of the stanchion 38 passes. The transverse dimension of the stanchion 38 and the hollow interior 63 of the sleeve or arm 62 is such as to provide telescopic, sliding engagement of the end 39 into and along the length of the interior 63. In addition, and as shown in FIG. 2, locking apertures 65 and 66 respectively formed in the stanchion 38 and the supporting sleeve 62 are relatively disposed so as to be aligned and allow the passage there-through of a locking pin or other structure which serves to secure the stanchion 38 to the support sleeve 62. Also, as shown in FIG. 4, the support sleeve 62 and hollow interior 63 may have a multi-sided configuration which substantially corresponds to a similar, multi-sided configuration of the exterior surface of the stanchion 38 so as to prevent relative rotation there between when the end 39 of the stanchion 38 is disposed within the hollow interior 63, as described above.

With reference to FIGS. 1-3, the support assembly 30 also comprises the first support portion 32, which may be more specifically described as the load support portion. As such, the load support portion 32 includes a mounting plate 70 and at least one but preferably a plurality of retaining members or tangs 72. The retaining members 72 are secured to an outer or exposed face 73 of the mounting plate 70 and are disposed in outwardly spaced relation thereto. A seat member 74 is disposed in interconnecting relation at a lower end of the space between the retaining members 72 and the plate 70. In addition, when at least two of the retaining members 72 are utilized, they are spaced a sufficient distance from one another, preferably at the opposite ends of the plate 70, to restrict lateral movement of the hand truck when it is mounted on the load support portion 32.

The effective functioning of the load support portion 32 will be explained, at least in part, based on the structural features and components of the preferred load 12 being in the form of the hand truck 20. Accordingly, and as shown in FIG. 1, the hand truck 20 includes an elongated frame 21 having a handle or gripping arm 23 secured to an upper or outer end of the frame 21 and extending along at least a portion of the length thereof. In order to assure the safe attachment of the frame 23 to the support assembly 22 in the position shown in FIG. 1, the assembly 10 also includes an attachment assembly 25 removably connected to the arm 23.

The mounting arm 56 is pivotally or otherwise movably connected as at 56′ to an upper portion of the hand truck 20, as shown in FIGS. 1 and 6. In addition, the hand truck 20 includes a pair of supporting wheels 125 interconnected by an axle 27. The axle 27 serves to rotatably mount the support wheels 125 on the lower end of the frame 21 so as to facilitate travel of the hand truck 20, by manual propulsion, over the ground or other supporting surface. The axle is connected by a plurality of brace members 29 structured to further support the frame 21 as well as any cargo 14, 14′ mounted on the hand truck 20 over the ground or supporting surface. Various types of cargo, 14 or 14′ may be positioned, at least in part, on a platform 31 which may vary in size so as to accommodate cargo components 14 and 14′ of various sizes, weights and configurations.

By virtue of at least one of the preferred embodiments of the load 12 being in the form of a hand truck 20 or like mobile carrier assembly, the load support portion 32 is structured in the manner described in order to best facilitate the mounting, positioning and support of the hand truck 20 on the base 22 and interconnected to the hitch structure 16 as shown in FIG. 1. Accordingly, the axle 27 is positionable within the space existing between the one or more retaining members 72 and the outer exposed surface 73 of the plate 70 by its passage through the open upper end 74′ of this space. When so positioned the axle 27 is supported on the seat 74 located between the one or more retaining members 72 and the plate 70, as set forth above.

As set forth above, the selective positioning of the boom 50 outwardly from the stanchion 38 into a variety of different longitudinal positions allows for the preferred positioning of the cable 44 and more specifically, the end connector 48. The cable 44 is thereby connected to the hand truck 20, or other load 12, at a location which facilitates its mounting on the support assembly 30 or its removal therefrom, as will be explained in greater detail with reference to FIGS. 1 and 7 through 10. More specifically, the location of the connection between the end connector 48 and the hand truck 20 should be such as to substantially align the cable with the combined center of gravity of the hand truck 20 and the cargo 14 or 14′.

In order to further provide for the effective mounting of the hand truck 20 on the load support portion 34, at least one preferred embodiment of the assembly 10 also includes a guide assembly 80. The guide assembly 80 comprises a guide structure 82 preferably having a slanted orientation as disclosed in FIG. 2. Proper alignment of the cable 44 with the center of gravity, as set forth above will facilitate interruptive engagement of the guide structure 82 with the axle 27 during the lifting of the hand truck 20 from the ground or other support surface onto the load supporting portion 32.

With reference to FIGS. 7 and 8, as the connecting cable 44 is wound onto the winch 40 the hand truck 20, with the cargo 14, 14′ mounted thereon, is lifted from the ground or other supporting surface. During such mounting procedure, when the cable 44 is located in the preferred position relative to the hand truck 20, the hand truck 20 will remain in a substantially vertical orientation. As the hand truck is being lifted, the guide structure 82 will interruptively engage axle 27 as it assumes the position “1” indicated in FIG. 8. Position “2” of the axle 27 indicates sliding engagement or travel of the axle 27 along the outer surface of the inclined or slanted guide member 82. Position “3” of axle 27 indicates its continued sliding engagement along the outer surface of the retainer members 72 until it passes over the open ends 74′ and above the space between the retaining members 72 and the mounting plate 70. Once in position “4”, the axle 27 will then be lowered by manipulation of the winch 40 until it engages and is supported on the seat 74 as shown in the final position “5” of FIG. 8.

In order to accomplish the intended movement of the axle 27 in the manner described with reference to FIG. 8, the boom 50 may be selectively positioned to have a shortened length as represented in FIG. 7. This will provide proper alignment of the cable 44 and the combined center of gravity of the hand truck 20 and cargo 14, 14′, as set forth above, and facilitate the axle 27 passing into the aforementioned interruptive engagement with the guide structure 82. Inward movement of the axle 27 as indicated by directional arrow 84 will also be accomplished due to the relative orientation of the cable 44 and the center of gravity of the combined hand truck 20 and the cargo 14, 14′, so as to dispose the axle 27 immediately above open end 74′.

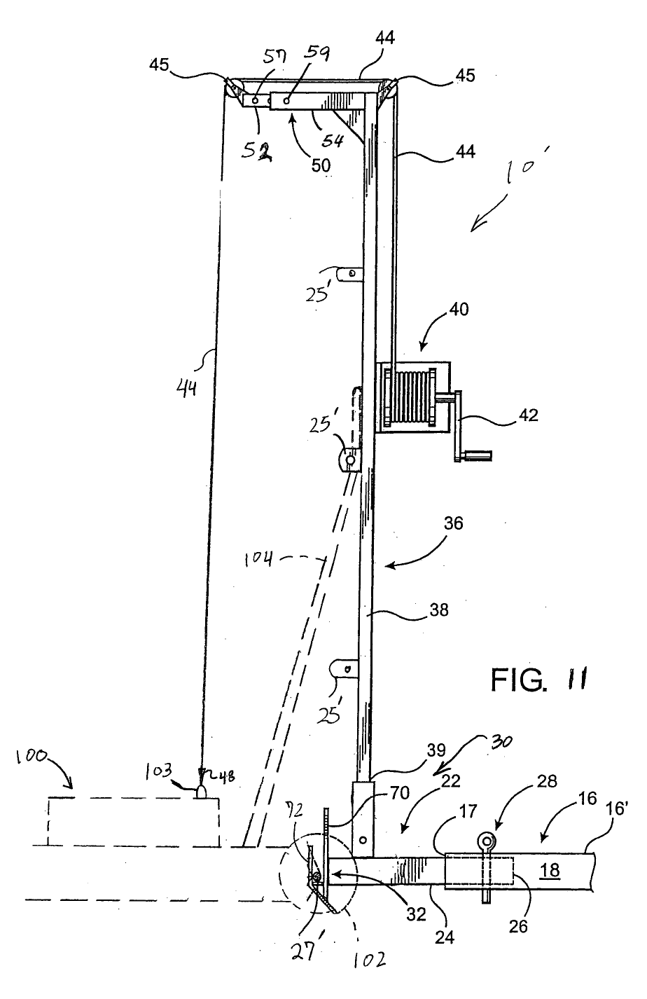

When it is desired to remove the hand truck 20 from its supported position on the load support portion 32, the boom 50 may be selectively extended outwardly to increase its overall length. This will have a tendency to force or bias the axle 27 somewhat outwardly away from the mounting plate 70 and retaining member 72. Accordingly, as the cable 44 lifts the axle 27 from it supported position on the load support portion 32, as shown in FIG. 10, it passes outwardly through the open end 74′ and away from the load support portion 32 as indicated by directional arrow 84′. The schematically represented sequential positions 1 through 4 of the axle 27, as also demonstrated in FIG. 10, indicates the movement of the axle when the cable and aforementioned center of gravity are properly aligned during the unloading procedure.

Therefore, the preferred or proper placement of the cable 44, and in particular, the location of attachment of the connector 48 to the load 12 is important in order to accomplish the tendency of the axle 27 to move or travel inwardly towards the various components of the load support portion 32 schematically demonstrated by the sequential positions 1 through 4 of FIG. 8 when being located as described above. To the contrary, the cable 44 has its position changed relative to the hand truck 20 by virtue of extending the length of the boom 50 as represented in FIG. 9. This outward extension of the boom 50 and the outward positioning of the cable 44 relative to the load 12 will cause the tendency of the axle 27 to move outwardly or away from the load support portion 32, as indicated by directional arrow 84′ and demonstrated in FIG. 10 when the hand truck 20 and the cargo 14, 14′ are removed from the load support portion 32.

As emphasized above, the location of the combined center of gravity of the load 12, or more specifically, the hand truck 20 and the cargo 14 or 14′ mounted thereon, is important to maintain the hand truck in a substantially vertical orientation during the loading and unloading thereof. Therefore, and by way of example only, when the cargo 14 assumes a first orientation indicated by the solid lines in FIG. 1, the center of gravity will shift inwardly in accordance with the reference arrow 90. This will require the boom 50 to assume a shortened length in order to establish a location of connection between the connector 48 and the mounting arm 56 in order to align the cable 44 with the center of gravity as indicated by the reference arrows 90.

To the contrary, when the cargo as at 14′ assumes a different position or in fact is a different cargo, the center of gravity will shift as indicated by phantom reference line 92. This causes a selective adjustment or positioning of the boom 50 to assume a somewhat greater length in order that the cable 44 is positioned in substantial alignment in accordance with the directional arrow 92.

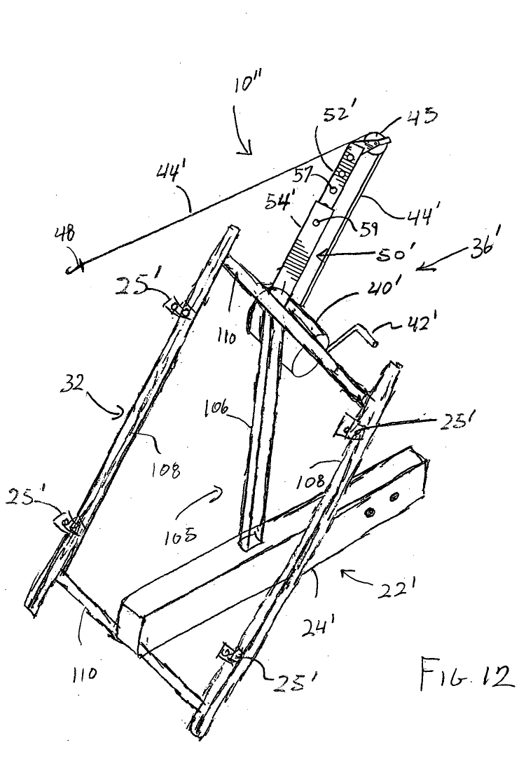

With reference to FIG. 11, yet another preferred embodiment of the present invention further demonstrates the structural and operational versatility of the assembly and is generally indicated as 10′. More specifically, the assembly 10′ is operative to support a cargo generally indicated as 100 which may be considered “mobile cargo” due to the fact that it incorporates its own wheeled support base or wheel assembly, schematically represented by one or more wheels 102. As such, the mobile cargo 100 does not require the use of a hand truck or other mobile carrier 20 as with the embodiment of FIGS. 1 through 10. However, the assembly 10′ is substantially equivalent to that of the preferred embodiment of the assembly 10 as described with reference to FIG. 1 with the distinguishing exception being the absence of the hand truck or other mobile carrier 12 being considered part of the load.

Accordingly, and as shown in FIG. 11 the assembly 10′ is structured to position, mount and support a mobile cargo 100 on the exterior of a vehicle by being removably connected or attached to a hitch structure, generally indicated as 16, which may be of conventional design. In addition, the assembly 10′ comprises a base 22 including a tongue 24 telescopically attached to the hitch structure 16, as described above. Further, the base 22 includes a support assembly generally indicated as 30 which includes first and second support portions 32 and 34 and a hoist assembly 36. Also, the hoist assembly 36 includes an elongated stanchion 38 extending upwardly and outwardly from the base 22 and the aforementioned winch 40. The winch 40 is connected in driving relation to a cable 44 which extends along a length of the stanchion 38 as well as along a length of an adjustably structured boom 50. The cable 44 has a connecting structure 48 which may be in the form of a hook, snap coupling, or other structure, capable of being connected to the mobile cargo 100. Preferably, but not necessarily, a specifically structured connecting point 103 on of the mobile cargo 100 is used to attach the connector or coupling 48. In order to maintain a proper, “upright” orientation of the mobile cargo 100 the specifically structured connecting point 103 is disposed in substantial alignment with the center of gravity of the mobile cargo 100. When a connecting point 103, which is specifically structured to receive the coupling 48, is not affixed to the mobile cargo 100, the coupling 48 should still be structured to connect the free end of the cable 44 to a portion of the mobile cargo 100 which is also in substantial alignment with the center of gravity thereof. As will be described in greater detail hereinafter, the cable 44 may or may not be aligned with the center of gravity of the mobile cargo 100, dependent at least in part on whether the mobile cargo 100 is being loaded onto the support portion 30, being supported thereon or being removed therefrom.

It should be noted that unlike the cargo 14 or 14′ demonstrated in FIG. 1, the center of gravity of the respective mobile cargo(s) 100 will be substantially constant. As such, the connection point 103 is disposed in substantial alignment with the center of gravity of each of the various mobile cargos 100. Attachment of the free end of the cable 44 to a location on the mobile cargo 100 which is in substantial alignment with its center of gravity will facilitate the preferred “upright” orientation of the mobile cargo 100, such as when it is suspended and supported by the cable 44 independent of the load support portion 32. Such a preferred, upright orientation of the mobile cargo 100 better accomplishes the “control” of the mobile cargo 100 as it is being loaded and unloaded on to the load support portion 32, as well as when it is supported thereon.

In this preferred embodiment of the present invention, the adjustable longitudinal positioning of the boom 50 relative to the stanchion 38 is important in properly locating the mobile cargo 100 relative to the load support portion 32 immediately prior to it being loaded, while it is supported thereon and while it is being unloaded therefrom. More specifically, assuming that the cable 44 is preferably connected to the mobile cargo 100 at a connecting point 103, the outward positioning of the boom 50 is adjusted such that the portion 27′ of the mobile cargo 100 is disposed in close proximity to the load support portion 32. This will facilitate the loading of the mobile cargo 100 on to the load support portion 32. Once the mobile cargo 100 is supported on the load support portion 32, the length of the boom 50 may again be adjusted to best accomplish secure, controlled orientation of the mobile cargo 100, such as when the vehicle is traveling. During the unloading procedure of the mobile cargo 100, the boom 50 may again be adjusted such as by being extended outwardly a sufficient distance from the stanchion 38 to allow the mobile cargo 100 and the supported portion 27′ to “swing away” from the load support portion 32.

Other factors which effect the outward extension of the boom 50 relative to the stanchion 38, as well as the positioning of the mobile cargo 100 relative to the load support portion 32, may include whether the vehicle is mounted on an incline. By way of example, if the vehicle is parked on a downhill incline, the boom 50 may be extended outwardly a greater than normal distance so that the mobile cargo 100 and the portion 27′ is properly located relative to the support portion 32. Conversely, if the vehicle is parked on an uphill incline, the length of the boom 50 or the outward extension thereof would be considerably smaller so as to again facilitate a controlled, secured position of the mobile cargo 100 and portion 27′ thereon relative to the load support portion 32.

As with the embodiment of FIG. 1, the load support portion 32 demonstrated in the embodiment of FIG. 11 also may include a mounting plate 70 and at least one but preferably a plurality of retaining members or tangs 72. However, it is emphasized that the load support portion 32 may vary significantly from the mounting plate 70 in its dimension, configuration and structure to accommodate any one of a plurality of different mobile cargos such as, but not limited to lawn mowers, snow blowers, generators, power washers, etc. It is further emphasized that the popularity and commercial utilization of the assembly 10′ of the present invention may be such that manufacturers of certain equipment, any of which would be considered a mobile cargo 100, may at least somewhat customize the structure thereof so as to facilitate its retaining engagement on the load support portion 32.

As set forth above, and for purposes of clarity, it is again emphasized that the load support portion 32 may comprise the aforementioned plate 70 and one or more tangs 72 and be disposed to engage and/or retain conventional or customized portion of the mobile cargo 100 such as, but not limited to, the portion 27′. Further structural modifications of the assembly 10′ differing from the previously described embodiments include the provision of one or more attachment members 25′. The attachment members 25′ may assume a variety of different locations and configurations so as to retain and be removably connected to other portions of the mobile cargo 100, such as an outwardly extending handle 104 as demonstrated. In addition, one or more of the attachment members 25′ could be adjustably mounted so as to be selectively positionable along the length of the stanchion 38, so as to be brought into registry and removable retaining engagement with a handle or other components 104 of the mobile cargo 100.

The loading of the mobile cargo 100 relative to the load support portion 32 will be substantially the same as demonstrated in the sequentially represented procedure of FIG. 8, described above. Similarly, removal of the mobile cargo 100 from its supported position, as demonstrated in FIG. 11, to a conventional position on the ground or other supporting surface is demonstrated by the sequentially represented procedure described with reference to FIG. 10. However, it is again emphasized that the proximal location of the portion 27′ of the mobile cargo 100 relative to the load support portion 32 to most efficiently accomplish the loading and unloading procedures, substantially as demonstrated in FIGS. 8 and 10 respectively, is due to the ability to adjustably regulate the length of the boom 50 relative to the stanchion 38, the load support portion 32 as well as the mobile cargo 100 itself.

As emphasized in detail above, the structural and operational versatility of the assembly of the present invention is such that it is capable of lifting and supporting a variety of different load/cargo combinations on a vehicle for safe and efficient transportation thereof. As also demonstrated, the load/cargo combinations may include the use of a hand truck or like mobile carrier defining part of the load and positioned to removably support a variety of different types of cargo, as described with reference to FIGS. 1 through 10. In the embodiment represented in FIG. 11, the use of a hand truck or like mobile carrier would be unnecessary due to the wheeled base or like wheel assembly 102 providing mobility to the cargo 100. There is yet another preferred embodiment of the assembly represented in FIGS. 12 through 15 and indicated generally by reference numeral 10″. Assembly 10″ is specifically structured to accommodate yet another load/cargo combination, wherein the load 12′ comprises a hand truck or like mobile carrier 20′ as well as cargo 100′ having an enlarged or otherwise relatively unusual size or configuration.

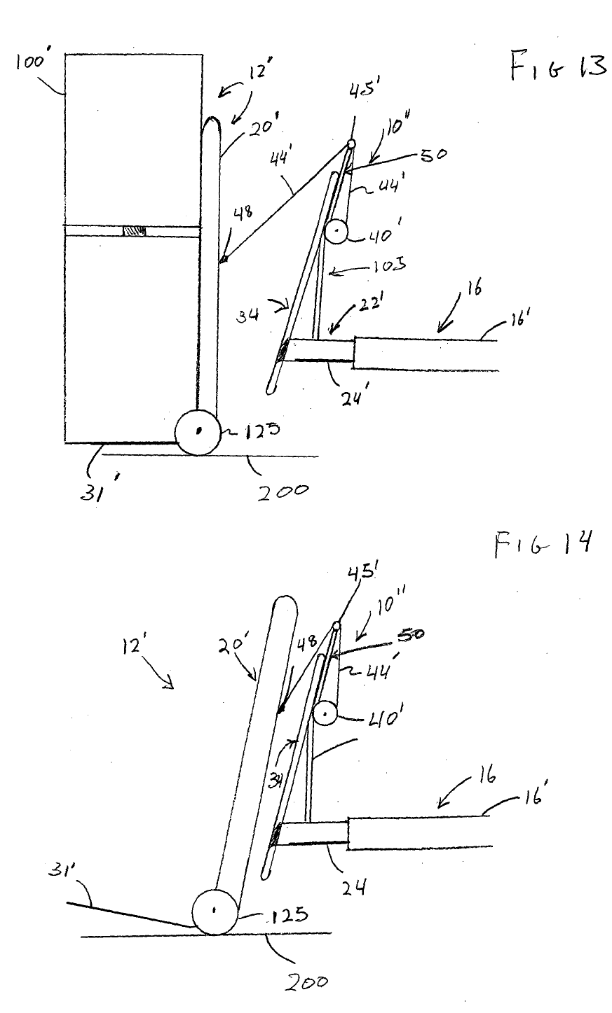

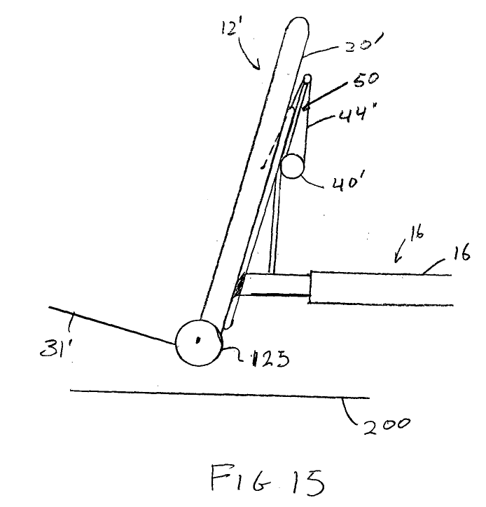

With reference to FIG. 13, the cargo 100′ is represented as being a refrigerator or any of a variety of other types of cargos wherein the height (or other aspects of its size or configuration) is such that it may not be capable of being lifted and supported utilizing the structure of the assembly 10 and 10′, as disclosed in FIGS. 1 and 11. Also, as will be discussed in greater detail hereinafter, the load 12′ may be further defined by a combination of the cargo 100′ and the mobile carrier 20′ or alternatively by the mobile carrier 20′ independently. However, for purposes of clarity, the load 12′ as represented in FIGS. 14 and 15 is absent the cargo 100′. However, the structural features of the assembly 10″ of this alternative preferred embodiment of the present invention as well as its operation would be substantially, if not exactly the same, whether or not a cargo 100′ is mounted on the mobile carrier 20′.

With reference now to FIG. 12, this preferred embodiment of the assembly 10″ comprises the base 22′ including the outwardly projecting tongue 24′ designed to be removably secured to the box type hitch 16 associated with a vehicle, not shown. The base 22′ is removable from the hitch assembly 16 and is connected to a support assembly 105 such that the support assembly 105 is removable with the base 22′ from the hitch 16. Moreover, the support assembly 105 includes at least one primary brace 106 extending upwardly from the tongue 24′ of the base 22′ into supporting engagement with the load support portion 32. The load support portion 32 in the embodiment of FIGS. 12 through 15 preferably comprises a frame like structure including side frames 108 disposed in spaced apart relation to one another and cross braces 110 interconnecting the side braces 108 and also being secured to the vertical brace 106. It is emphasized that the specific structural configuration of the load support portion 32 may vary from that shown in FIG. 12 and include additional components as well as secure attachment thereof to the base 22′ as well as the vertical brace 106 at various locations.

The assembly 10″ further includes a hoist assembly 36′ including a winch 40′ connected in driving relation to a cable 44′. The winch assembly 36′ further includes a boom 50′ which in at least one embodiment of the assembly 10″ may include a mounting arm 54′ and an arm segment 52′ which is adjustable longitudinally relative to the length of the boom 50′ as well as the mounting arm 54′. As such, the boom 50′ at least partially defines a path of travel of the cable 44′ from the winch 40′ to the free end or coupling member 48 which serves to removably connect the cable 44′ to the load 12′. It should be further noted that the boom 50′ may be connected to a variety of locations in cooperative association with the winch 40′ such as being attached to or integrally formed with the vertical brace 106 or attached to or integrally formed on other portions of the frame assembly defining the load support portion 32. Also, rather than include the adjustably connected mounting arm 54′ and arm segment 52′, the boom 50′ can be of a substantially one piece structure which is not adjustable along its length but which extends outwardly from the support assembly 105 as well as the load support portion 32 in a position which does not interfere with the location of the load 12′, when then load 12′ is disposed in its operative, supported position as demonstrated in FIG. 15.

As set forth above, the load support portion 32 may assume a variety of different structures, configurations, sizes, etc. best suited to accommodate support and movable engagement with the load 12′, in particular the mobile carrier 20′. More specifically, the load support portion 32 includes a guide assembly, which in the embodiment of FIG. 12 comprises at least the spaced apart side rails 108 which may be disposed, dimensioned and otherwise structurally configured to slidingly engage corresponding portions, such as the side rails of the mobile carrier 20′, as clearly evident from a review of FIGS. 14 and 15. Further, in order to safely maintain the load 12′ in the supported, operative position for traveling as demonstrated in FIG. 15, the load support portion 32 includes at least one but preferably a plurality of retainer members 25′, each of which may have a variety of different structures and configurations so as to be removably attached in retaining engagement with the mobile carrier 20′ as should be evident. The one or more retainer members 25′ could be substantially equivalent to the U-shaped retainer brackets or coupling members 25′ associated with the embodiments of FIGS. 1 and 11, as set forth above.

In operation, the load 12′, which may comprise the oversized cargo 100′ as well as the mobile carrier 20′, is initially disposed on the ground or other supporting surface 200 in somewhat adjacent relation to the assembly 10″. In such a position, the cable 44′ is connected to an appropriate part or location on the mobile carrier 20′ as demonstrated in FIG. 13. Once so connected the load 12′, including at least the mobile carrier 20′ may be moved somewhat closer to the assembly 10″ upon activation of the winch 40′ and a “reeling in” of the cable 44′. Movement of the load 12′ is of course facilitated by the wheel assembly 125 associated with the mobile carrier 12′. Concurrent activation of the winch 40′ will cause the load 12′, including the mobile carrier 20′ as well as the cargo 100′ to tilt into the preferred, predetermined orientation best suited for supporting the load 12′ on the assembly 10″, as well as its transportation by the vehicle associated with the hitch assembly 16. The positioning of the load 12′ in the aforementioned angularly oriented or inclined orientation as demonstrated in FIGS. 14 and 15 is further facilitated by the path of travel of the cable 44′ and location where the free end coupling 48 is secured to the mobile carrier 20′. As the loading process proceeds, the load 12′ including the mobile carrier 20′ and possibly the cargo 100′, is lifted from the ground or other supporting surface 200 and fully assumes the preferred, predetermined angular or inclined orientation corresponding to the preferred angular or inclined orientation of the load support portion 32.

Again with reference to FIG. 12, it is clearly evident that the load support portion 32 including the guide means defined by the side member or braces 108 are disposed at a preferred, predetermined, angular or inclined orientation relative to the substantial horizontal positioning of the base 22′, and of course, the ground or other supporting surface 200. Therefore, when the load 12′ is in the operative, supported position for transportation as represented in FIG. 15, the mobile carrier 20′ and any cargo 100′ also assumes the preferred and angular or inclined orientation which corresponds to the inclined orientation of the load support portion 32.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An assembly for removably supporting cargo on the exterior of a vehicle, said assembly comprising:
a) a base connected to a hitch structure on the vehicle and including a support assembly secured to said base,
b) a hoist including a winch and a cable connected in driven relation to said winch, said cable connected directly to the cargo,
c) said hoist assembly further including a stanchion and a boom, said boom adjustably positionable a spaced distance from said stanchion,
d) said boom and said stanchion collectively and at least partially defining a path of travel of said cable between said winch and the cargo,
e) said support assembly comprising a load support portion disposed in interconnected relation to the hitch structure, and
f) said spaced distance of said boom relative to said stanchion determinative of a proximity of the cargo relative to said load support portion.

2. An assembly as recited in claim 1 wherein said cable is connected to said cargo at a predetermined connecting point, said connecting point disposed in substantially aligned relation to a center of gravity of the cargo.

3. An assembly as recited in claim 1 wherein said boom is adjustably positionable relative to the cargo.

4. An assembly as recited in claim 1 wherein said support assembly further comprises a stanchion support portion secured to said base in interconnected relation to the hitch structure on the vehicle.

5. An assembly as recited in claim 4 wherein said load support portion and said stanchion support portion are fixedly secured to said base and removable with said base from the hitch structure.

6. An assembly as recited in claim 1 wherein said load support portion comprises at least one retaining member secured in outwardly spaced relation to a remainder of said support assembly, said retaining member disposed and structured to removably retain the cargo on said support assembly.

7. An assembly as recited in claim 1 wherein said boom comprises an arm segment movably connected to a remainder of said boom and longitudinally positionable relative thereto so as to selectively vary the length of said boom and the position of the cargo relative to said support assembly at least when the cargo is not retained on said support assembly.

8. An assembly as recited in claim 1 wherein said support assembly is structured to concurrently support the cargo and the hoist assembly on the exterior of the vehicle in interconnected relation to the hitch structure.

9. An assembly as recited in claim 8 wherein said load support portion is secured to said base and structured to removably support the cargo on the vehicle.

10. An assembly as recited in claim 9 wherein said boom is selectively positionable relative to said support assembly so as to facilitate retaining engagement of the cargo with said load support portion as the cargo is lifted from a supporting surface by said cable.

11. An assembly as recited in claim 10 wherein said load support portion comprises a mounting plate and at least one retaining member secured to said mounting plate and disposed in outwardly spaced relation thereto, said mounting plate and said retaining member cooperatively structured and disposed to removably support the cargo on said support assembly.

12. An assembly as recited in claim 11 wherein said load support portion and said stanchion support portion are fixedly secured to said base and concurrently removable with said base from the hitch structure.

13. An assembly for removably supporting cargo on an exterior of a vehicle, said assembly comprising:
a) a base connected to a hitch structure on the vehicle and including a support assembly secured to said base,
b) said hoist including a winch and a cable connected in driven relation to said winch,
c) a load comprising a mobile carrier structured to support the cargo thereon,
d) said hoist assembly further including a boom extending outwardly from said support assembly,
e) said boom at least partially defining a path of travel of said cable between said winch and said load,
f) said support assembly including a load support portion disposed in an inclined orientation and structured to support said mobile carrier in a substantially corresponding inclined orientation on the exterior of the vehicle in interconnected relation to the hitch structure, and
g) said cable connected to said mobile carrier at a predetermined location thereon which facilitates support of said load in said corresponding inclined orientation when said mobile carrier is lifted from a supporting surface.

14. An assembly as recited in claim 13 wherein said boom is adjustably positionable relative to said support assembly.

15. An assembly as recited in claim 13 wherein said load support portion is secured to said base in interconnected relation to the hitch structure on the vehicle.

16. An assembly as recited in claim 15 wherein said load support portion is fixedly secured to said base and removable with said base from the hitch structure.

17. An assembly as recited in claim 15 wherein said load support portion comprises at least one retaining member extending outwardly therefrom in retaining relation to said mobile carrier, said retaining member cooperatively disposed and structured to removably retain said mobile carrier in said corresponding inclined orientation.

18. An assembly as recited in claim 16 wherein said load support portion comprises a guide assembly disposable in at least partially supporting engagement with said mobile carrier.

19. An assembly as recited in claim 18 wherein said guide assembly is disposed in said inclined orientation and is structured to engage said mobile carrier upon activation of said winch as said load is lifted from a supporting surface into retaining engagement with said load support portion.

20. An assembly as recited in claim 19 wherein said boom is selectively positionable relative to said support assembly so as to facilitate interruptive, slidable engagement of said guide assembly with said mobile carrier as said load is lifted from a supporting surface into retaining engagement with said load support portion by said cable.

21. An assembly as recited in claim 20 wherein said boom comprises an arm segment movably connected to a remainder of said boom and longitudinally positionable relative thereto so as to selectively vary a position of said boom and said path of travel of said cable relative to said load and said load support portion.

22. An assembly for removably supporting cargo on an exterior of a vehicle, said assembly comprising:
a) a base connected to a hitch structure on the vehicle and including a support assembly secured to said base,
b) a hoist including a winch and a cable connected in driven relation to said winch,
c) said hoist further including a boom extending outwardly from said support assembly and at least partially defining a path of travel of said cable between said winch and the cargo,
d) said support assembly including a load support portion disposed and structured to support cargo in a predetermined orientation on the exterior of the vehicle in interconnected relation to the hitch structure, and
e) said cable connected in supporting relation to the cargo at a location which facilitates disposition of said cargo in said predetermined orientation when the cargo is lifted from a supporting surface upon activation of said winch.

23. An assembly as recited in claim 22 further comprising a load including a mobile carrier structured to support the cargo thereon, said load support portion disposed in an inclined orientation substantially defining said predetermined orientation of the cargo.

24. An assembly as recited in claim 23 wherein said load support portion comprises a guide assembly disposed in said inclined orientation and structured to movably and at least partially support said mobile carrier upon activation of said winch as said load is lifted from a supporting surface into retaining engagement with said load support portion.

25. An assembly as recited in claim 22 wherein said hoist further includes a stanchion connected to said boom, said boom and said stanchion collectively and at least partially defining said path of travel of said cable connected directly to the cargo at a location thereon which facilitates orientation of said cable in a substantially aligned relation to a center of gravity of the cargo, at least when said cargo is not supported on said support assembly.

26. An assembly as recited in claim 25 wherein said support assembly comprises a cargo engaging portion having at least one retaining member secured in outwardly spaced relation to a remainder of said support assembly, said retaining member disposed and structured to removably retain the cargo on said support assembly.

27. An assembly as recited in claim 26 wherein said load support portion further comprises a cargo support portion secured to said base and structured to removably support the cargo on the vehicle.

28. An assembly as recited in claim 22 wherein said boom comprises an arm segment movably connected to a remainder of said boom and longitudinally positionable relative thereto so as to selectively vary the length of said boom and the position of said cable and the cargo relative to said support assembly.
